(19) United States
(12) Patent Application Publication
(10) Pub. No.: US 2012/0246095 A1
(43) Pub. Date: Sep. 27, 2012

(54) Resampled Efficient Frontiers for Portfolios with Derivative Overlays

(75) Inventors: Robert Michaud, Boston, MA (US); Richard O. Michaud, Boston, MA (US)

(73) Assignee: MICHAUD PARTNERS LLP., Boston, MA (US)

(21) Appl. No.: 13/428,751

(22) Filed: Mar. 23, 2012

Related U.S. Application Data
(60) Provisional application No. 61/465,900, filed on Mar. 25, 2011.

(51) Int. Cl. G06Q 40/06

(52) U.S. Cl. 705/36 R

(57) ABSTRACT

Computer-implemented methods for constructing a risk-return optimal allocation to a set of assets, where a subset of the assets is at least partially insured or modified by the addition of derivative securities. The methods entail resampling a plurality of sets of returns consistent with a return distribution for each asset, with at least one asset modified by a derivative overlay, subject to terms of at least one contract requirement. A statistical mean of associated optimal portfolios is established, generating a resampled efficient frontier, on the basis of which a portfolio weight is selected for each asset according to a specified risk objective.

The present application claims priority from U.S. Provisional Application Ser. No. 61/465,900, filed Mar. 25, 2011, which is incorporated herein by reference.

### TECHNICAL FIELD

The present invention relates to methods and computer implemented program code for optimizing a portfolio of assets, financial or otherwise, wherein, more particularly, assets are subject, at least in part, to one or more derivative overlays.

### BACKGROUND OF THE INVENTION

An investor's investments are typically expressed as asset allocations. Assets may be in invested in various classes of domestic and international stocks, real estate, fixed income, and many other categories of investable and non-investable securities. Investment advisors and financial economists typically recommend that asset allocations are optimized with respect to estimated return relative to risk.

The Markowitz (1959) mean-variance (MV) efficient frontier is the classical paradigm for defining asset allocation optimality. Given a set of risk and returns for the asset classes, the Markowitz frontier provides optimal asset allocations for a given level of investor risk as defined by the portfolio standard deviation.

In practice, the Markowitz efficient frontier is known to have important investment limitations including over sensitivity to estimate errors resulting in unmarketable and often poorly performing portfolios. The Resampled Efficient Frontier (REF), described in detail in Michaud (1998) and in U.S. Pat. No. 6,003,018 (hereinafter, Michaud '018), uses resampling techniques to moderate the level of uncertainty in investment information in the optimization process resulting in more intuitive and better performing investment portfolios.

Asset allocation based on the Michaud Resampled Efficient Frontier is described in Michaud (1998) as well as in Michaud et al., Efficient Asset Management (2d ed., 2008, and in U.S. Pat. Nos. 6,928,418, 7,412,414 and 7,624,060, all of which are incorporated herein by reference.

FIG. 1 illustrates optimal allocations 11-18 to various assets along the entire efficient frontier. The efficient frontier used to generate FIG. 1 was constructed using Michaud's Resampled Efficient Frontier, as fully described in Michaud (1998) and Michaud (2008), and in Michaud '018. The computation of the efficient frontier illustrated used 18 years of history for eight asset classes: US 11 and Euro bonds 12, and equities for Germany 13, Japan 14, France 15, UK 16, Canada 17, and the US 18, as described in Michaud (1998). The height of each band on the y-axis represents the optimal allocations of each asset to one of 51 of the efficient frontier portfolios for this data set, where the optimal portfolios are ordered from lowest risk, on the left, to highest risk (and return), on the right. The optimal allocation to US equities 18 shown in the lowest band for each point of the efficient frontier should be noted in particular, as it will be compared with results obtained by practice of the present invention, as described below.

### SUMMARY OF EMBODIMENTS OF THE INVENTION

In accordance with embodiments of the invention, methods and program codes are provided for constructing a risk-return optimal allocation to a set of assets, a subset of which, including the entirety thereof, being at least partially insured or modified by the addition of derivative securities. The methods and program code have steps and program modules for:
a. resampling a plurality of sets of returns consistent with a return distribution for each asset, wherein sampled returns of at least one asset are modified by the requirements of terms of at least one derivative overlay contract;
b. computing an optimal portfolio based on each set of resampled returns;
c. associating each optimal portfolio with a specified set of portfolios for creating a set of associated optimal portfolios;
d. establishing a statistical mean for each set of associated optimal portfolios, thereby generating a plurality of statistical means, the plurality of statistical means defining a resampled efficient frontier;
e. selecting a portfolio weight for each asset from the resampled efficient frontier associated according to a specified risk objective; and
f. investing funds in accordance with the specified portfolio weights.

In accordance with further embodiments of the present invention, an asset or asset class may be represented both in a protected and an unprotected version. Moreover, one or more of the asset classes may comprise purely derivative assets.

In accordance with alternate embodiments of the present invention, a computer program product may be provided for use on a computer system for constructing a risk-return optimal allocation to a set of assets, a subset of which, including the entirety thereof, being at least partially insured or modified by the addition of derivative securities. The computer program product has a computer usable medium having computer readable program code thereon. The computer readable program code includes:
a. a routine for resampling a plurality of sets of returns consistent with a return distribution for each asset, wherein sampled returns of at least one asset are modified by a derivative overlay, subject to terms of at least one contract requirement;
b. program code for computing an optimal portfolio based on each set of resampled returns;
c. program code for associating each optimal portfolio with a specified set of portfolios for creating a set of associated optimal portfolios;
d. a module for establishing a statistical mean for each set of associated optimal portfolios, thereby generating a plurality of statistical means, the plurality of statistical means defining a resampled efficient frontier; and
e. program code for selecting a portfolio weight for each asset from the resampled efficient frontier associated according to a specified risk objective.

### BRIEF DESCRIPTION OF THE DRAWINGS

The foregoing features of the invention will be more readily understood by reference to the following detailed description, taken with reference to the accompanying drawings, in which:

FIG. 1 is an optimal portfolio map depicting an optimal allocation of asset classes for portfolios of varying degrees of risk as determined using methods of Michaud (1998, 2008).

FIG. 2 is a flowchart depicting steps for constructing an optimal allocation of assets subject to a derivative overlay in accordance with an embodiment of the present invention.

FIG. 3 is an optimal portfolio map wherein the class of US assets has been modified to reflect full coverage by put options to prevent losses in any given month, in accordance with embodiments of the present invention.

FIG. 4 is an optimal portfolio map wherein the class of US assets has been modified to reflect full coverage of all component of the class by put options and sale, for each component, of a fully covered call, in accordance with embodiments of the present invention.

FIG. 5 is an optimal portfolio map wherein the class of US assets has been augmented by a separate asset class that is the class of US assets modified to reflect full coverage of all component of the class by put options, in accordance with embodiments of the present invention.

FIG. 6 shows one embodiment of a computer that may be used to implement aspects of the invention.

### DETAILED DESCRIPTION OF EMBODIMENTS OF THE INVENTION

### Definitions

As used herein, and in any appended claims, the following terms shall have the meanings now described, unless the context requires otherwise:

The term “portfolio” shall refer to any aggregation of component “assets,” where the respective weights of component assets define a vector in a space referred to as “portfolio space.”

“Contract terms,” as applied to a derivative such as an option, include changes to the return (by virtue of the cost of the option cost or premium, for example), thereby modifying the return percent or coverage ratio associated with the contract or set of contracts.

The process of “resampling” to which reference is made herein and in one or more claims appended hereto, might be performed, within the scope of the present invention, by sequentially drawing a random series of returns subject to a distribution, or, alternatively, by directly sampling a multivariate return distribution of a set of assets.

### Asset Allocation Derivative Overlay Strategies

In many cases, investors have relatively short-term views of markets or assets that they wish to implement with various derivative strategies. For example, in a period of economic uncertainty, an investor may want to protect the possibility of a significant decline in domestic equities by buying a put on the index representing the class of securities. An alternative strategy may be to sell a call on an index in order to obtain additional income in exchange for potential loss of upside return. These and many other derivative based strategies are often proposed to manage the risk of an asset allocation relative to investment views and objectives.

A simple example of a derivative is an option. An option is a contract for buying or selling a security at a stated price within a given time period. The required inputs include the exercise or stated price, investment period, and cost or premium associated with the contract. In an asset allocation context, an additional parameter, the coverage ratio, is required that specifies what percent of total value of the asset covered by the option. Other examples include, without limitation, credit default swaps, etc.

Description of Resampled Efficient Frontier (REF) Optimization with Derivatives

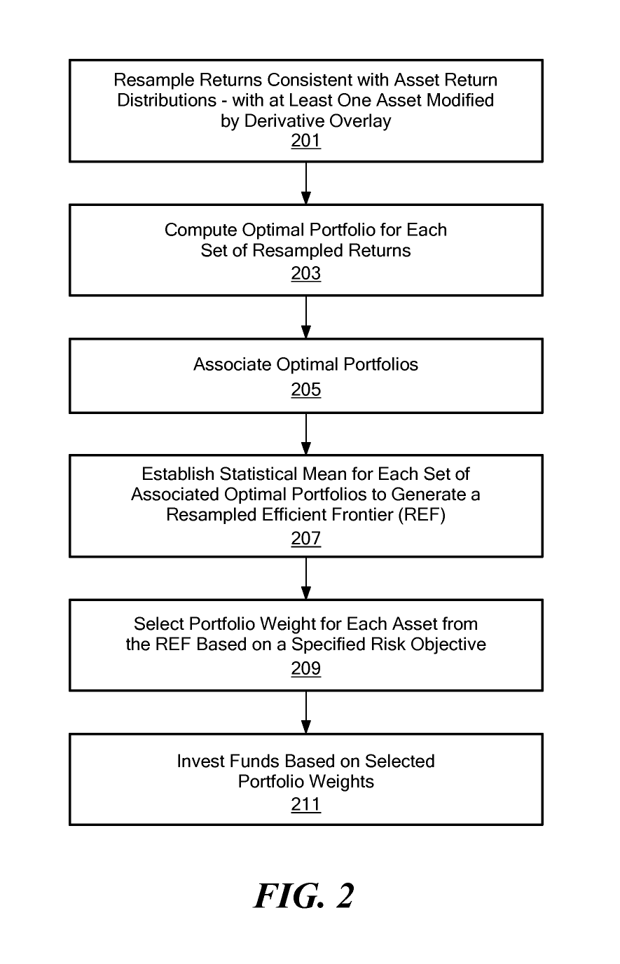

Methods for constructing risk-return optimal allocation of funds to a set of assets are now described with reference to FIG. 2. The REF optimization process, as described in Michaud (1998, 2008) and in Michaud '018, is modified to replace the usual resampling step to include the return distribution with a derivative overlay. For example, if a put option is bought on an asset class the returns in a specific scenario may be capped beyond a certain loss, at the cost of a loss of return, equal to the price of the option, in every scenario. Given the inputs, the REF optimization considers risk-return estimates of all assets or securities in the investment and adjusts the allocations for calls, puts, or other options or derivatives included in the optimization.

REF optimization begins with resampling returns (201) consistent with asset return distributions, where at least one asset has been modified by a derivative overlay of the sort that has been described. As described above, the term “resampling” is used broadly, within the scope of the present invention, and may encompass sequentially drawing a random series of returns subject to a distribution, or, alternatively, by directly sampling a multivariate return distribution of a set of assets.

For each set of resampled returns, an optimal portfolio is computed (203) using standard optimization. Optimal portfolios are associated (205) and a statistical mean is established for each set of associated optimal portfolios (207) as described in detail in Michaud (1998, 2008) and Michaud '018. The end result is the creation of a new set of optimal asset allocations that include the costs or premiums associated with each derivative at various strike prices and coverage ratios.

### A Derivative Overlay Conditional Efficient Frontier

A new frontier of optimal asset allocations for each level of investor risk emerges. One a specified risk objective is specified, portfolio weights may be selected (209) for each asset or asset class subject to the foregoing optimization. The new format provides a highly time efficient framework for evaluating the benefits and consequences of various proposed derivative strategies relative to a given investor's asset allocation. The framework is very flexible allowing for a very wide spectrum of derivative overlay strategies with precise prescriptions of asset allocation optimality at each desired investor risk level.

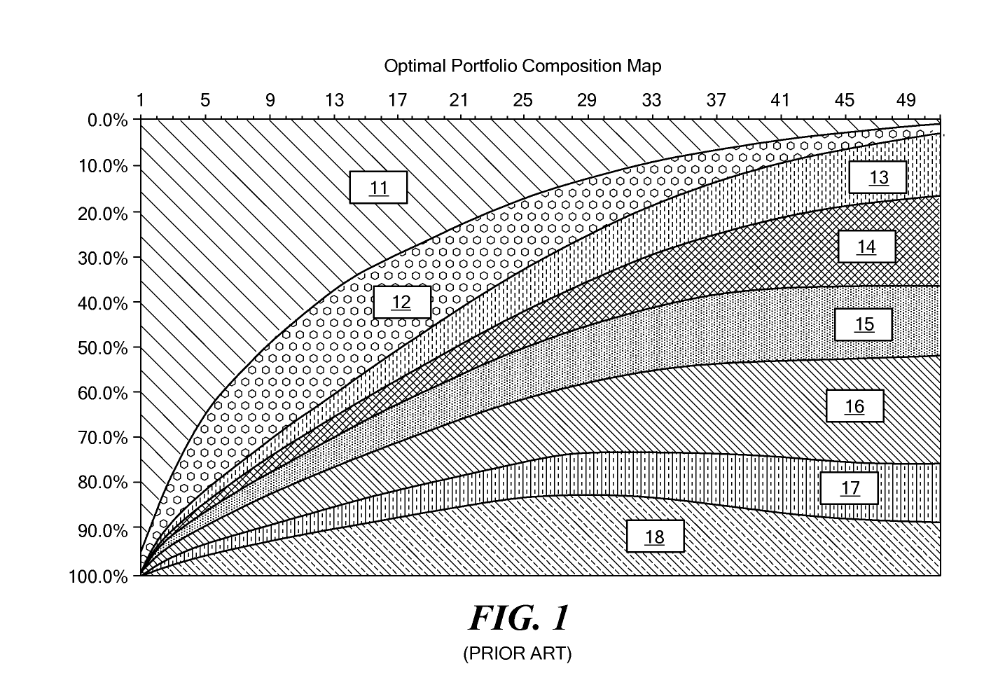

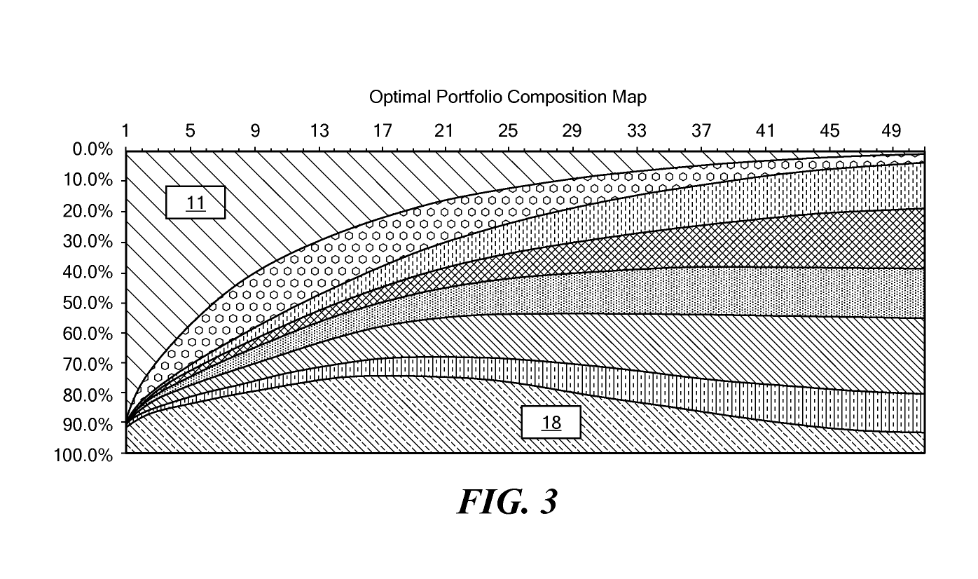

One example of an application of embodiments of the present invention is now described with reference to FIG. 3. In the example shown in FIG. 3, optimal allocations to various assets along the entire efficient frontier are shown for the same eight asset classes depicted in FIG. 1, based upon 18 years of history for the asset classes shown. In this example, US asset returns are modified to simulate the returns of US equities, fully covered by put options preventing losses in any given month. The coverage ratio for the asset is a variable of the procedure. The height of each band on the y-axis represents the allocation of each asset to one of 51 optimal asset allocation portfolios where the portfolios are ordered from lowest risk to highest risk (and return). Allocation to the bottom US equities asset class 18 is notable, in this allocation is now to US equities with a put option. This allocation is significantly higher than the optimal allocation to plain US equities, shown in FIG. 1, at low to moderate risk levels. The greater proportion of US equities in an optimal portfolio reflects the investment fact that US equities constitute a much less risky asset with a put option overlay strategy.

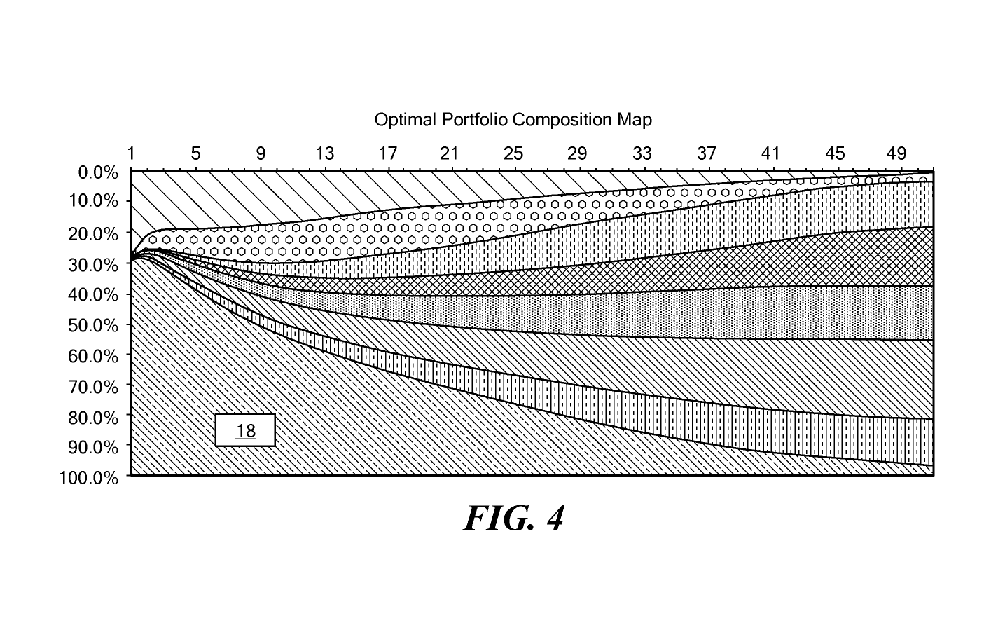

In a second example, depicted in FIG. 4, a “collar” strategy is applied to the asset class of US equities 18 where the assets of asset class 18 are fully covered by put options, thereby preventing losses in any given month, while, at the same time, a fully-covered call is assumed to be sold, giving up all returns above a certain value. Again, the allocation to the US equities asset class 18 should be noted, namely, the allocation to US equities with a collar. This allocation is much higher than the optimal allocation to plain US equities in the base case, depicted in FIG. 1, at low to moderate risk levels. At the same time, the allocation to asset class 18 is lower at high risk levels reflecting the investment fact that US equities are a much less risky asset relative to downside events, while, at the same time, also a more attractive asset by providing income relative to the sale of the fully covered call.

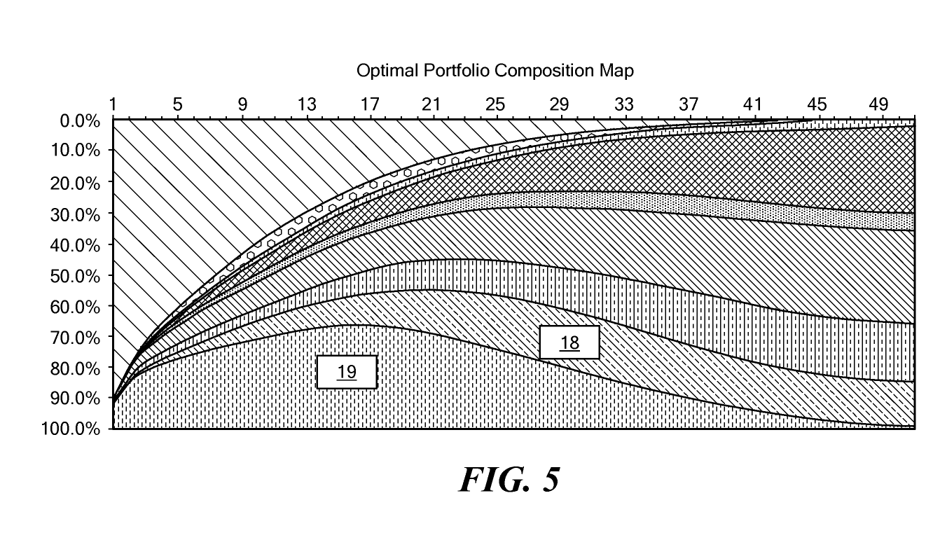

Specifying a level of coverage of the derivative strategies is an option of the procedure, in accordance with embodiments of the present invention. In a third example, described with reference to FIG. 5, an uncovered asset class of US equities 18 is included in the optimization alongside a corresponding US equities asset class 19 where the assets of asset class 19 are covered by put options. The insured US equities 19 are prevalent in low and moderate risk portfolios, but disappear at high risk levels, while the standard US equity asset 18 is optimal at moderate and high risk levels. Thus, an optimal level of insurance may be determined. In yet further embodiments of the present invention, a derivative may constitute a separate asset for purposes of optimization, whether or not the underlying asset is already included in the optimization universe.

Once an optimal asset allocation has been determined in accordance with a specified risk objective, funds are invested (211, shown in FIG. 2) in accordance with the portfolio weights determined to be optimal for that specified risk objective.

In addition to the application of the present invention to actual derivative overlays, it is to be understood that methods in accordance with the present invention may also be applied to tailoring return distributions in any manner, as by simulating the cut-off of returns on the low side (as by a put option overlay), or on the high side (as by the sale of a call option), etc., for example.

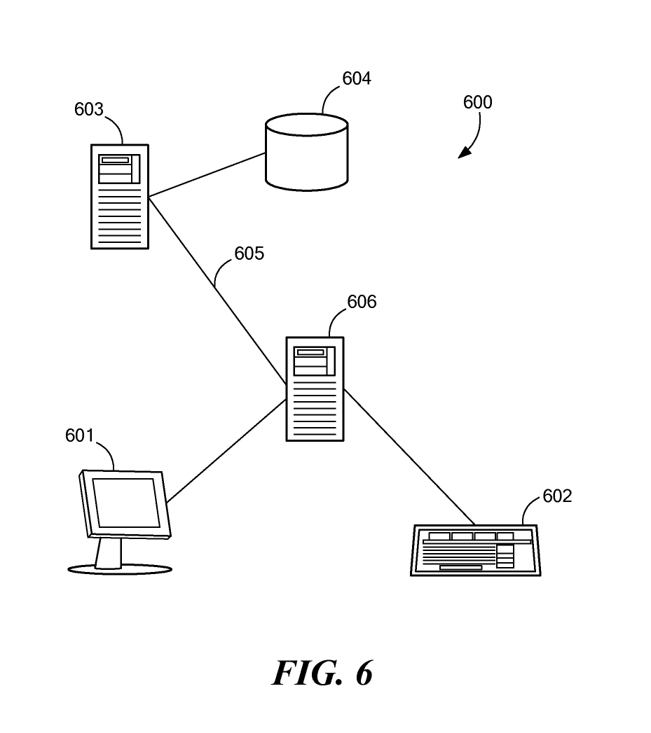

Various aspects of the invention may be implemented as specialized software executing in a general-purpose computer system 600 such as that shown in FIG. 6. The computer system 600 may include a database server 603 connected to one or more memory devices 604, such as a disk drive, memory, or other device for storing data. Database server 603 stores an investor portfolio comprising a plurality of assets, or other data to which the present invention may be applied. A processing server 605 contains computer-executable software configured to derive a threshold as taught in the foregoing description. Memory 604 is typically used for storing programs and data during operation of the computer system 600. Components of computer system 600 may be coupled by an interconnection mechanism 605, which may include one or more busses (e.g., between components that are integrated within a same machine) and/or a network (e.g., between components that reside on separate discrete machines). The interconnection mechanism 605 enables communications (e.g., data, instructions) to be exchanged between system components of system 600. Computer system 600 also includes one or more input devices 602, for example, a keyboard, mouse, trackball, microphone, touch screen, and one or more output devices 601, for example, a printing device, display screen, speaker. In addition, computer system 600 may contain one or more interfaces (not shown) that connect computer system 600 to a communication network (in addition or as an alternative to the interconnection mechanism).

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 600 is shown by way of example as one type of computer system upon which various aspects of the invention may be practiced, it should be appreciated that aspects of the invention are not limited to being implemented on the computer system as shown in FIG. 6. Various aspects of the invention may be practiced on one or more computers having a different architecture or components than that shown in FIG. 6. Computer system 600 may be a general-purpose computer system that is programmable using a high-level computer programming language. Computer system 600 may be also implemented using specially programmed, special purpose hardware. In computer system 600, servers 603 and 605 are typically implemented on one or more commercially available servers.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate, or interpreted code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A computer-implemented method for constructing a risk-return optimal allocation to a set of assets, a subset of which, including the entirety thereof, being at least partially insured or modified by the addition of derivative securities, the method comprising:
a. resampling a plurality of sets of returns consistent with a return distribution for each asset, wherein sampled returns of at least one asset are modified by a derivative overlay, subject to terms of at least one contract requirement;
b. computing an optimal portfolio based on each set of resampled returns;
c. associating each optimal portfolio with a specified set of portfolios for creating a set of associated optimal portfolios;
d. establishing a statistical mean for each set of associated optimal portfolios, thereby generating a plurality of statistical means, the plurality of statistical means defining a resampled efficient frontier;
e. selecting a portfolio weight for each asset from the resampled efficient frontier associated according to a specified risk objective; and
f. investing funds in accordance with the specified portfolio weights.

2. A computer-implemented method in accordance with claim 1, wherein the at least one asset modified by a derivative overlay is also represented as an asset class without a derivative overlay.

3. A computer-implemented method in accordance with claim 1, wherein at least one of the assets of the set of assets comprises a purely derivative asset.

4. A computer program product for use on a computer system for constructing a risk-return optimal allocation to a set of assets, a subset of which, including the entirety thereof, being at least partially insured or modified by the addition of derivative securities, the computer program product comprising a computer usable medium having computer readable program code thereon, the computer readable program code including:
a. a routine for resampling a plurality of sets of returns consistent with a return distribution for each asset, wherein sampled returns of at least one asset are modified by a derivative overlay, subject to terms of at least one contract requirement;
b. program code for computing an optimal portfolio based on each set of resampled returns;
c. program code for associating each optimal portfolio with a specified set of portfolios for creating a set of associated optimal portfolios;
d. a module for establishing a statistical mean for each set of associated optimal portfolios, thereby generating a plurality of statistical means, the plurality of statistical means defining a resampled efficient frontier; and
e. program code for selecting a portfolio weight for each asset from the resampled efficient frontier associated according to a specified risk objective.
